(19) United States
(12) Patent Application Publication
(10) Pub. No.: US 2013/0335021 A1
(43) Pub. Date: Dec. 19, 2013

(54) CHARGING CONNECTION APPARATUS FOR A MOTOR VEHICLE

(71) Applicant: Dr. Ing. h.c.F. Porsche Aktiengesellschaft, Stuttgart (DE)

(72) Inventor: Steffen Meier, Freudental (DE)

(21) Appl. No.: 13/917,059

(22) Filed: Jun. 13, 2013

(30) Foreign Application Priority Data
Jun. 14, 2012 (DE) 10 2012 105 139.9

(51) Int. Cl. B60L 11/18

(52) U.S. Cl. CPC B60L 11/1818
USPC 320/109

(57) ABSTRACT

A motor vehicle (2) has a vehicle body (4) and at least one electrical energy storage means. A charging connection apparatus is mounted to the vehicle body (4) and can be connected to a charging plug (8) supplied from the outside for charging the electrical energy storage means. The charging connection apparatus has an adapter (10) mounted to the vehicle body (4), a charging housing (12) mounted to the adapter (10) and a plug (14) mounted in the charging housing (12). The plug (14) is connected to the electrical energy storage means and can be connected to the charging plug (8). The adapter (10), the charging housing (12) and the plug (14) are configured to conform to the charging plug (8) in the country where the motor vehicle (2) is used.

### CROSS REFERENCE TO RELATED APPLICATION

This application claims priority under 35 USC 119 to German Patent Appl. No. 10 2012 105 139.9 filed on Jun. 14, 2012, the entire disclosure of which is incorporated herein by reference.

### BACKGROUND OF THE INVENTION

1. Field of the Invention

The invention relates to a charging connection apparatus for a motor vehicle for charging at least one electrical energy storage means that is connected electrically to a plug part arranged in a vehicle body by means of a housing so that the plug part can be connected to a charging plug supplied from the outside.

2. Description of the Related Art

Charging connection apparatuses have been known in the prior art for a long time. Motor vehicles equipped with charging connection apparatuses of this kind generally are called plug-in hybrid vehicles or plug-in electric vehicles, depending on the motor concept chosen. An energy storage means, usually a battery, of the vehicle can be charged, for example, by connecting the charging connection apparatus to an external power supply network, whether by means of a charging station or the freely accessible power supply network.

An arrangement in which a charging housing part is provided with a plug part in a vehicle body is known, for example, from FR 2 954 261. As in the case of the domestic power supply network, there now also are a large number of charging plugs of different design for supplying power to the plug-in vehicles. Accordingly, the vehicle in question has to be equipped with the connection apparatus that matches the charging plug for the countries in question. This requires a great deal of assembly effort and therefore is costly.

The object of the invention is to provide a charging connection apparatus that avoids the abovementioned disadvantages in a cost-effective manner.

### SUMMARY OF THE INVENTION

The invention relates to an adapter for releasable or non-releasable connection to the vehicle body. A housing is to be fit to the adapter and a plug is fit to the housing. Thus, the vehicle body can be designed in a uniform manner in spite of the different requirements with respect to plug-in technology in the different countries in which the vehicle is sold. The vehicle manufacturer merely has to select the corresponding adapter, housing and plug combination during final assembly. The adapter can be connected releasably or non-releasably to the vehicle body in a known manner. The known releasable and non-releasable connection options also are available for assembly of the housing and plug in the adapter.

The adapter advantageously can be produced from a sheet metal profile. In this case, adapter can have positioning means, for example small cutouts, pins, etc., for connection to the vehicle body with an accurate fit.

The adapter, the charging housing and the plug may form a preassembled unit to achieve a particularly simple and cost-effective assembly. The adapter also advantageously can have various hole patterns for connection to different charging housings to reduce the number of different adapters given suitable external dimensions of different housings.

The charging housing may have a sealing housing to ensure optimum sealing between the vehicle body and the charging housing. The sealing housing also can be made of a different material, for example a flexible plastic to avoid an arrangement that is excessively rigid, and therefore at risk of fracture.

The invention is explained in detail below with reference to the drawings.

### BRIEF DESCRIPTION OF THE DRAWINGS

FIG. 1 is a side view of a plug-in motor vehicle.

FIG. 2 is a perspective view of a preassembled unit comprising an adapter, a charging housing and a plug.

FIG. 3 is a sectional view through a charging connection apparatus arranged in a vehicle body.

### DETAILED DESCRIPTION OF THE PREFERRED EMBODIMENTS

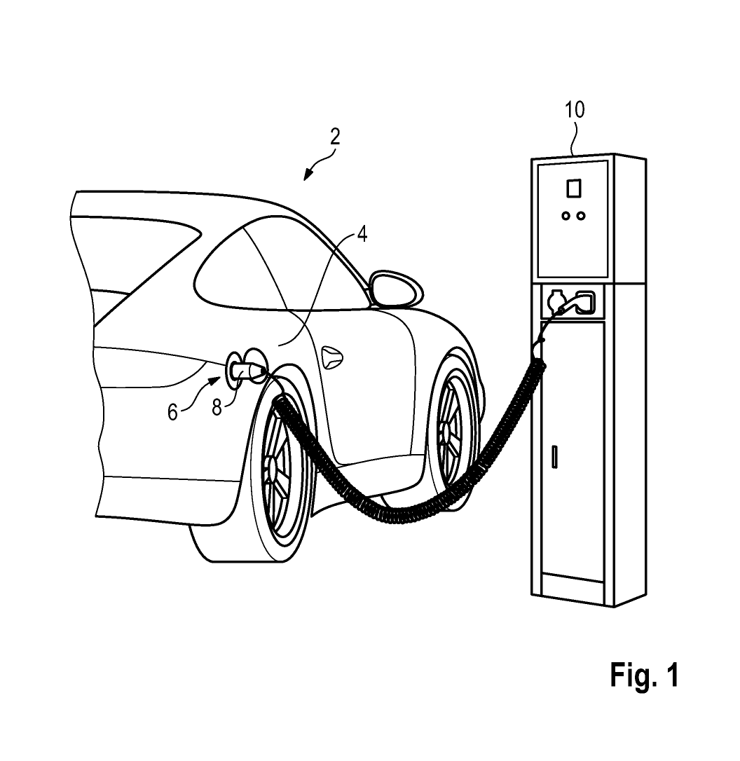

FIG. 1 is a perspective partial view of a motor vehicle 2 with a vehicle body 4 and a charging connection apparatus 6 arranged in the vehicle body 4. A charging plug 8 of an external charging station 10 engages in the charging connection apparatus 6 for electrically charge an energy storage means—not illustrated. This type of motor vehicle 2 generally is called a plug-in motor vehicle.

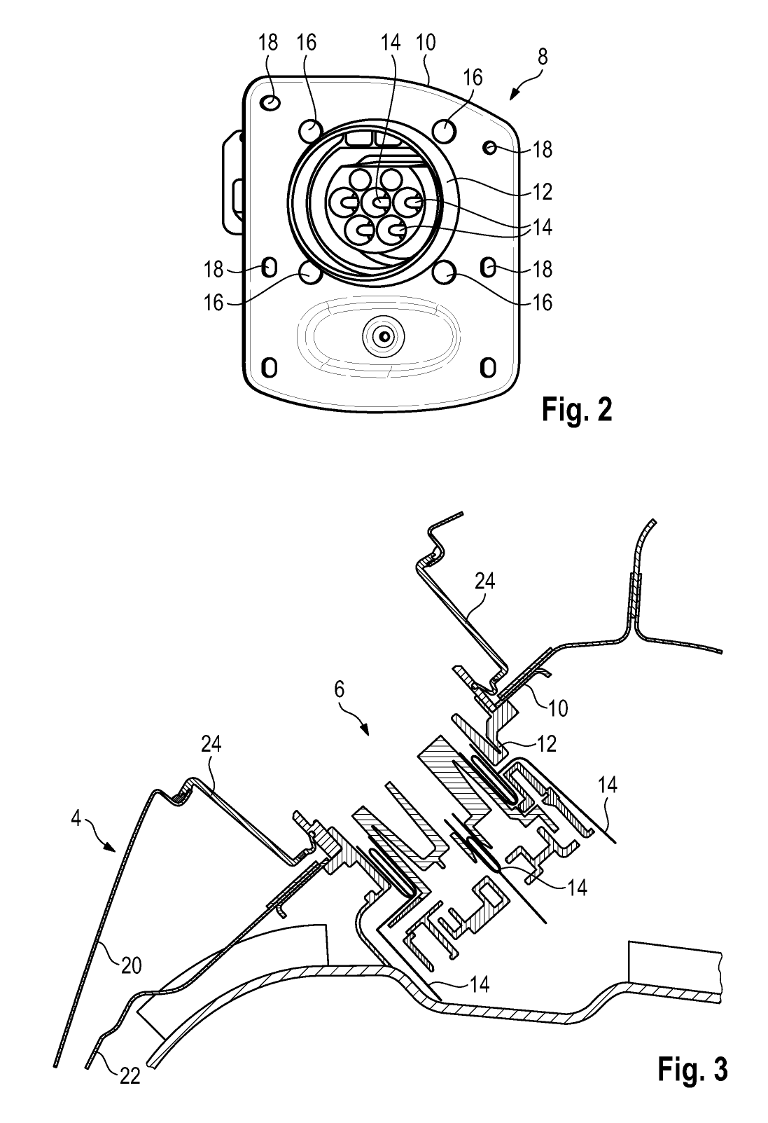

FIG. 2 shows an embodiment of a charging connection apparatus 8 according to the invention. The charging connection apparatus 8 is designed as a preassembled unit and comprises an adapter 10, a charging housing 12 and a plug 14, with only the connection plugs of the plug 14 being partially illustrated. The charging housing 12 is connected to the adapter 10 by rivet connections 16. Unit cutouts 18 are provided in the adapter 10 for releasable or non-releasable connection to the vehicle body 4. Connection options include weld or solder connections and rivet or screw connections. Furthermore, the adapter 10 can have positioning means for connection to the vehicle body 4 with an accurate fit. It is also feasible for the adapter 10 to have various hole patterns for connection to different charging housings 12.

FIG. 3 is a sectional view of a further embodiment of a charging connection apparatus 6 arranged in the vehicle body 4. The vehicle body 4 comprises external vehicle body parts 20 and internal vehicle body parts 22. The charging housing 12 with the plug 14 is arranged in the adapter 10. The adapter 10 is welded to the inner part 22 of the vehicle body in the present exemplary embodiment. Furthermore, the adapter 10 also has a sealing housing 24 that is connected in a non-releasable manner to the outer part 20 of the vehicle body 4 and accordingly ensures that the charging connection apparatus 6 is sealed off from the vehicle body 4.

What is claimed is:

1. A charging connection apparatus for a motor vehicle for charging at least one electrical energy storage in the motor vehicle, the charging connection apparatus comprising:
an adapter having an outer peripheral region, connection areas inward from the outer peripheral region and configured for releasably or non-releasably connectable to a vehicle body and a plug mounting opening inward from the connection areas;
a charging housing mounted to the adapter so that at least part of the charging housing is in the mounting opening and accessible from outside the motor vehicle, the charging housing being configured to connect with a charging plug supplied from outside in the country in which motor vehicle is used; and
a plug arranged in the charging housing and being connected electrically to the electrical energy storage, the plug being connectable to conductors in the charging plug supplied from outside.

2. The charging connection apparatus of claim 1, wherein the adapter is produced from a sheet metal profile.

3. The charging connection apparatus of claim 1, wherein the adapter has positioning means for connection to the vehicle body with an accurate fit.

4. The charging connection apparatus of claim 1, wherein the adapter, the charging housing and the plug form a preassembled unit.

5. The charging connection apparatus of claim 1, wherein the adapter has plural hole patterns for connection to charging housings of different shapes.

6. The charging connection apparatus of claim 1, further comprising a sealing housing (24) between the charging housing and the vehicle body.

7. A motor vehicle, comprising:
a body having external and internal vehicle body parts;
an electrical energy storage;
an adapter having connection areas connected to the internal vehicle body part and a plug mounting opening inward from the connection areas;
a charging housing mounted to the adapter so that at least part of the charging housing is in the mounting opening and accessible from outside the motor vehicle;
a sealing housing extending between the charging housing and the external vehicle body part; and
a plug arranged in the charging housing and being connected electrically to the electrical energy storage, the plug and the charging housing being configured to connect with a charging plug supplied from outside in the country in which motor vehicle is used.

8. The motor vehicle of claim 7, wherein the adapter is produced from a sheet metal profile.

9. The motor vehicle of claim 7, wherein the adapter has plural hole patterns for connection to charging housings of different shapes.
